(19) United States
(12) Patent Application Publication
(10) Pub. No.: US 2025/0308084 A1
(43) Pub. Date: Oct. 2, 2025

(54) VIDEO PROCESSING METHOD AND DEVICE

(71) Applicant: Beijing Zitiao Network Technology Co., Ltd., Beijing (CN)

(72) Inventors: Wenfeng LIN, Beijing (CN); Mingyu GUO, Beijing (CN); Jiao RAN, Beijing (CN)

(21) Appl. No.: 19/028,823

(22) Filed: Jan. 17, 2025

(30) Foreign Application Priority Data
Apr. 2, 2024 (CN) 202410397001.8

(51) Int. Cl. G06T 11/00; G06K 19/06; G06T 3/40; G06T 3/60; G06V 10/74; G06V 20/40

(52) U.S. Cl. CPC G06T 11/00; G06K 19/06028; G06K 19/06037; G06T 3/40; G06T 3/60; G06V 10/761; G06V 20/48

(57) ABSTRACT

The present disclosure provides a video processing method, including: generating a graphic code based on additional information to be fused into a first video; obtaining a plurality of first video frames of the first video; determining at least one first target video frame from the plurality of first video frames; fusing the graphic code with the first target video frame; replacing the first target video frame in the plurality of first video frames with a corresponding second target video frame to obtain a plurality of second video frames; and generating a second video.

### CROSS-REFERENCE TO RELATED APPLICATIONS

The present disclosure is based on and claims priority of Chinese Application No. 202410397001.8, filed on Apr. 2, 2024, the disclosure of which is hereby incorporated into this disclosure by reference in its entirety.

### TECHNICAL FIELD

The present disclosure relates to the field of artificial intelligence technologies, and in particular, to a video processing method and a related device.

### BACKGROUND

With the popularity of medium and short videos, the need to add text information to videos is also growing. Generally, such information is added to video images in the form of text watermarks. However, this method is too rigid, and the added information may often block the content of the images, which is likely to cause aversion from users. Therefore, how to add additional information to a video without affecting the user's perception of the video is one of the problems that need to be solved urgently in video processing at present.

### SUMMARY

In view of this, some embodiments of the present disclosure provide a video processing method, by which additional information can be fused into at least one video frame of a video in the form of a graphic code, and the graphic code fused into the video frame can be fused with a video image and does not affect the overall perception of the user on the video. In addition, the user may also use a camera of a user terminal to scan the graphic code fused into the video, so as to obtain the additional information carried by the graphic code.

The video processing method according to the embodiments of the present disclosure may comprise: generating a graphic code based on additional information to be fused into a first video; obtaining a plurality of first video frames of the first video; determining at least one first target video frame from the plurality of first video frames based on the graphic code; for each first target video frame of the first target video frames, fusing the graphic code with the first target video frame by using the graphic code as a control condition and the first target video frame as an input condition, to obtain a second target video frame corresponding to the first target video frame and fused with the graphic code; replacing the first target video frame in the plurality of first video frames with a corresponding second target video frame to obtain a plurality of second video frames; and generating a second video based on the plurality of second video frames.

In the embodiments of the present disclosure, generating a graphic code based on additional information to be fused into a first video comprises: determining a format of the graphic code based on a type of the additional information and/or a size of an amount of information contained in the additional information, wherein the format of the graphic code comprises a bar code and a two-dimensional code; and encoding the additional information based on the format of the graphic code to obtain the graphic code.

In the embodiments of the present disclosure, obtaining the plurality of first video frames of the first video comprises: performing frame extraction processing on the first video to obtain the plurality of first video frames.

In the embodiments of the present disclosure, determining at least one first target video frame from the plurality of first video frames based on the graphic code comprises: determining a matching degree between each first video frame of the first video frames and the graphic code; and selecting the at least one first target video frame from the plurality of first video frames based on a preset frame selection ratio and the matching degree between the first video frame and the graphic code.

In the embodiments of the present disclosure, determining at least one first target video frame from the plurality of first video frames based on the graphic code comprises: dividing the plurality of first video frames into a plurality of video frame groups in chronological order; determining a first number of first target video frames in each video frame group based on a preset frame selection ratio; determining a matching degree between each first video frame of the first video frames and the graphic code; and selecting, from the each video frame group, the first number of first video frames with a highest matching degree as the first target video frames.

In the embodiments of the present disclosure, determining a matching degree between each first video frame and the graphic code comprises: for the first video frame, fusing the graphic code into the first video frame to obtain a third video frame; and determining a similarity between the third video frame and a corresponding first video frame of the third video frame, and using the similarity as the matching degree between the first video frame and the graphic code.

In the embodiments of the present disclosure, fusing the graphic code into the first video frame comprises: determining at least one image fusion mode based on at least one of a preset graphic code size, at least one rotation angle, and at least one position; for each image fusion mode, determining an image area on the first video frame where the graphic code is located based on the graphic code size, the rotation angle, and the position in the image fusion mode, adjusting the size and the rotation angle of the graphic code based on the graphic code size and the rotation angle in the image fusion mode, and adding adjusted graphic code to the image area of the first video frame to obtain a video frame fused with the graphic code; and selecting, from a plurality of video frames fused with the graphic code and corresponding to the same first video frame, a video frame with a highest similarity to the first video frame as the third video frame.

In the embodiments of the present disclosure, the image generation model is implemented by a diffusion model obtained through training.

In the embodiments of the present disclosure, the diffusion model comprises one of a stable diffusion model comprising a control network plug-in, a diffusion model based on a transformer architecture, or a T2I adapter.

Corresponding to the above video processing method, some embodiments of the present disclosure further provide a video processing apparatus. The above video processing apparatus comprises:
a graphic code module, configured to generate a graphic code based on additional information to be fused into a first video;
a frame extraction module, configured to obtain a plurality of first video frames of the first video;
a frame selection module, configured to determine at least one first target video frame from the plurality of first video frames based on the graphic code;
an image fusion module, configured to fuse the graphic code with each first target video frame by using the graphic code as a control condition and the first target video frame as an input condition, to obtain a second target video frame corresponding to the first target video frame and fused with the graphic code, for each first target video frame;
a video frame replacement module, configured to replace the first target video frame in the plurality of first video frames with a corresponding second target video frame to obtain a plurality of second video frames; and
a video synthesis module, configured to generate a second video based on the plurality of second video frames.

In addition, some embodiments of the present disclosure further provide an electronic device, comprising: a memory, a processor, and a computer program stored in the memory and executable on the processor, wherein the processor, when executing the program, implements the above video processing method.

Some embodiments of the present disclosure further provide a non-transitory computer-readable storage medium, wherein the non-transitory computer-readable storage medium stores computer instructions, and the computer instructions are used to cause a computer to execute the above video processing method.

Some embodiments of the present disclosure further provide a computer program product, comprising computer program instructions, wherein the computer program instructions, when run on a computer, cause the computer to execute the above video processing method.

It can be seen that some embodiments of the present disclosure provide a solution for fusing additional information into a video image, by which additional information can be fused into at least one video frame of a video in the form of a graphic code. The solution provided by the embodiments of the present disclosure can turn a video into a video that can be scanned while keeping the content of the video image basically unchanged. Further, the solution provided by the embodiments of the present disclosure reduces the sense of incongruity of the graphic code in the video image through a fusion algorithm for image generation and control, so that the graphic code fused into the video frame can be fused with the video image, and thus the overall perception of the user on the video is not affected.

### BRIEF DESCRIPTION OF THE DRAWINGS

In order to more clearly illustrate the technical solutions in the present disclosure or the related art, the following will briefly introduce the drawings that need to be used in the description of the embodiments or the related art. Obviously, the drawings in the following description are only embodiments of the present disclosure, and for those of ordinary skill in the art, other drawings can be obtained based on these drawings without creative efforts.

FIG. 1 shows an implementation flow of a video processing method provided by some embodiments of the present disclosure;

FIG. 2 shows an implementation flow of a method for generating a graphic code provided by some embodiments of the present disclosure;

FIG. 3 shows an implementation flow of a method for selecting a first target video frame from first video frames provided by some embodiments of the present disclosure;

FIG. 4 is a schematic diagram of an internal structure of a video processing apparatus according to some embodiments of the present disclosure;

FIG. 5A, FIG. 5B, and FIG. 5C respectively give examples of a first target video frame fused with a graphic code obtained by using the video processing method according to some embodiments of the present disclosure; and

FIG. 6 shows a schematic diagram of a more specific hardware structure of an electronic device according to some embodiments of the present disclosure.

### DETAILED DESCRIPTION

In order to make the objects, technical solutions and advantages of the present disclosure clearer, the present disclosure will be further described in detail below with reference to specific embodiments and drawings.

It should be noted that, unless otherwise defined, the technical terms or scientific terms used in the embodiments of the present disclosure should have the general meanings as understood by those of ordinary skill in the art to which the present disclosure belongs. “First”, “Second” and similar words used in the embodiments of the present disclosure do not indicate any order, number or importance, but are only used to distinguish different components. Words such as “include” or “comprise” mean that the elements or items appearing in front of the word cover the elements or items listed after the word and their equivalents, without excluding other elements or items. Words such as “connect” or “connected” are not limited to physical or mechanical connections, but may include electrical connections, whether direct or indirect. “up”, “down”, “left”, “right”, etc. are only used to indicate relative positional relationships, and when the absolute position of the described object changes, the relative positional relationship may also change accordingly.

It can be understood that before using the technical solutions of the embodiments in the present disclosure, the user will be informed of the type, scope of use, use scenarios, etc. of the involved personal information in an appropriate way, and the authorization of the user will be obtained.

For example, in response to receiving an active request from a user, prompt information is sent to the user to clearly inform the user that the operation requested to be performed will require the acquisition and use of the user's personal information. Thus, the user can independently choose whether to provide the personal information to the software or hardware such as the electronic device, the application, the server, or the storage medium that performs the operations of the technical solutions of the present disclosure according to the prompt information.

As an optional but non-limiting implementation, the method of sending prompt information to the user in response to accepting the active request of the user may be, for example, a pop-up window, and the prompt information may be presented in the pop-up window in text. In addition, the pop-up window may also carry a selection control for the user to choose “agree” or “disagree” to provide the personal information to the electronic device.

It can be understood that the above process of notifying and acquiring the user's authorization is only illustrative and does not limit the implementations of the present disclosure, and other methods that meet the relevant laws and regulations may also be applied to the implementations of the present disclosure.

As mentioned above, at this stage, additional information such as text is usually added to video images in the form of text watermarks, with the object of providing users with more additional information. However, this method of text watermarks is too rigid, and the added information may often block the content of the images, which is likely to cause aversion from users. Therefore, how to add additional information to a video without affecting the viewing of the video is one of the problems that need to be solved urgently in video processing at present.

In order to solve the above problem, some embodiments of the present disclosure provide a video processing method, by which additional information can be fused into at least one video frame of a video in the form of a graphic code, and the graphic code fused into the video frame can be fused with a video image, thereby not affecting the user's perception of the video. In addition, the user may also use a camera of a user terminal to scan the graphic code fused into the video, thereby acquiring the additional information carried by the above graphic code.

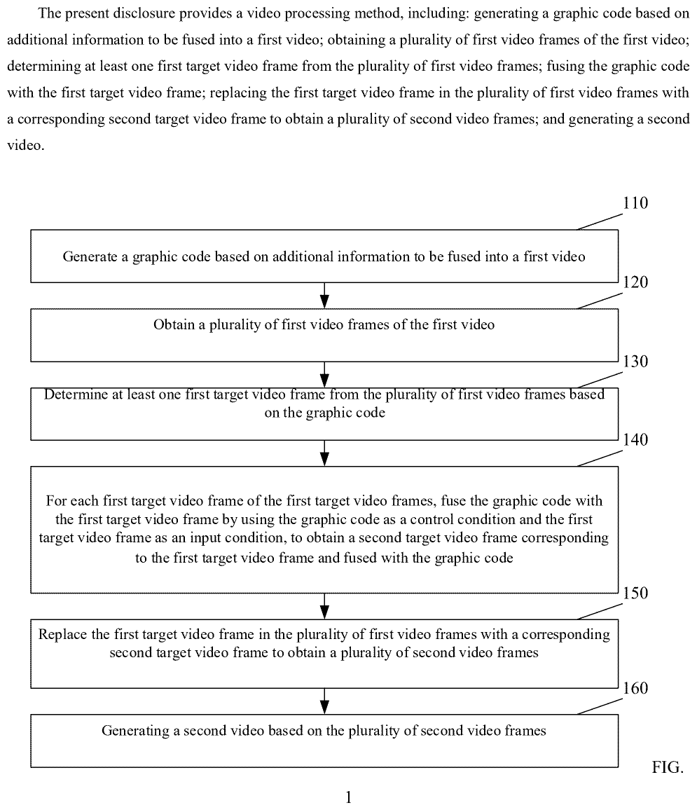

FIG. 1 shows an implementation flow of a video processing method provided by some embodiments of the present disclosure. As shown in FIG. 1, the above video processing method may comprise the following steps.

In step 110, a graphic code is generated based on additional information to be fused into a first video.

In step 120, a plurality of first video frames of the first video are obtained.

In step 130, at least one first target video frame is determined from the plurality of first video frames based on the above graphic code.

The at least one first target video frame specifically refers to a video frame used to carry the above graphic code.

In step 140, for each first target video frame, the graphic code is fused with the first target video frame by using the graphic code as a control condition and the first target video frame as an input condition, to obtain a second target video frame corresponding to the first target video frame and fused with the graphic code.

In step 150, the first target video frame in the plurality of first video frames is replaced with a corresponding second target video frame to obtain a plurality of second video frames.

In step 160, a second video is generated based on the plurality of second video frames.

The specific implementation method of each step in the above video processing method will be described in detail below with reference to the drawings and specific examples.

For the above step 110, in the embodiments of the present disclosure, the above first video may be a video shot and uploaded by a user, or may be a video generated by a video generation model of artificial intelligence. The embodiments of the present disclosure do not limit the source and content of the above first video.

In addition, in the embodiments of the present disclosure, the above additional information to be fused into the video may usually be text information, such as description information associated with the content of the video or address links (such as network addresses) of other associated content, etc. In addition, the above additional information may also be information in other forms besides text. It should be noted that the embodiments of the present disclosure do not limit the specific content and form of the above additional information.

Furthermore, in the embodiments of the present disclosure, the above graphic code may adopt a variety of graphic code formats, such as a bar code or a two-dimensional code. Moreover, the above two-dimensional code may also be a regular shape such as square, circular or ring, or other irregular shapes. The embodiments of the present disclosure do not limit the specific format and shape of the above graphic code.

In the above step 110, the above graphic code may be generated by a method as shown in FIG. 2. Specifically, the above method for generating a graphic code may comprise:

In step 210, a format of the graphic code is determined based on a type of the additional information and/or a size of an amount of information contained in the additional information.

It can be understood that, compared with a bar code, a two-dimensional code can carry a larger amount of information, and therefore, the two-dimensional code format may be adopted for additional information containing a relatively large amount of information. In addition, in practical applications, text information such as an address link is also usually carried by using a two-dimensional code. Therefore, in the above step 210, whether the format of the graphic code is a bar code or a two-dimensional code may usually be determined based on the type of the additional information and/or the size of the amount of information contained in the additional information.

In step 220, the additional information is encoded based on the format of the graphic code to obtain a graphic code corresponding to the additional information.

In the embodiments of the present disclosure, in the above step 220, after the format of the graphic code is determined, encoding of the additional information may be completed based on a corresponding graphic code standard, so as to obtain a graphic code corresponding to the additional information. It can be understood that generally, the image code corresponding to the additional information obtained by encoding is also in an image format. It should be noted that the embodiments of the present disclosure do not limit the specific encoding method.

For the above step 120, in the embodiments of the present disclosure, frame extraction processing may be performed on the above first video to obtain the above video comprising a plurality of first video frames. Specifically, the above frame extraction may be to extract all video frames of the above first video, or may be to extract some video frames of the above first video at a certain time interval. It should be noted that the embodiments of the present disclosure do not limit the specific method adopted for the above frame extraction processing.

For the above step 130, in some embodiments of the present disclosure, the at least one first target video frame may be selected from the plurality of first video frames based on a preset frame selection ratio and a matching degree between each first video frame of the first video frames and the above graphic code.

As mentioned above, the at least one first target video frame specifically refers to a video frame used to carry the above graphic code. Those skilled in the art can understand that, in order to better fuse the graphic code with the image in the video frame and keep the style and content of the image basically unchanged, a video frame with rich texture or rich light and shadow changes should usually be selected as the above first target video frame, so as to facilitate the fusion of the above graphic code without “traces”. Therefore, in the embodiments of the present disclosure, in the above step 130, the matching degree between the first video frame and the above graphic code may be determined first; then, the number of first target video frames to be selected may be determined based on the above frame selection ratio; finally, the first video frame with a higher matching degree is selected from the first video frames as the above first target video frame.

In the embodiments of the present disclosure, the above matching degree characterizes the degree to which a video frame is suitable for fusing the graphic code. Generally, the richer the texture, the more suitable the video frame is for fusing the graphic code, that is, the higher the matching degree with the graphic code.

Specifically, in the embodiments of the present disclosure, the matching degree between a certain first video frame and the above graphic code may be determined by the following method: first, the graphic code is fused into the above first video frame to obtain a third video frame corresponding to the above first video frame; then, the similarity between the above third video frame and its corresponding first video frame is determined, and the similarity is used as the matching degree between the above first video frame and the above graphic code. It can be seen that in the above method, the first video frame and the third video frame respectively represent two video frames before and after the graphic code is fused. Therefore, the higher the similarity between the two video frames, the more suitable the first video frame is for fusing the graphic code, that is, the smaller the impact on the user's perception after the graphic code is fused. In some specific examples, the similarity between the above third video frame and its corresponding first video frame may be determined by a difference between the third video frame and its corresponding first video frame. That is, the smaller the difference between the two video frames, the greater the similarity between the two video frames.

Further, in the embodiments of the present disclosure, in order to fuse the above graphic code into a certain first video frame to generate a third video frame, at least one graphic code size, at least one rotation angle, and at least one position may be preset. The above graphic code size defines the size of the graphic code relative to the image of the first video frame; the above rotation angle defines the rotation angle of the graphic code relative to the first video frame; and the above position defines the position of the graphic code in the first video frame. By presetting at least one graphic code size, at least one rotation angle, and at least one position, and combining the above three conditions, multiple relative positions and proportional relationships between the graphic code and the first video frame may be obtained, that is, multiple image fusion modes for fusing with the first video frame are obtained. Furthermore, for the image fusion mode, the shape of the graphic code may be further considered, such as square, circular, or ring, etc. In this way, when the graphic code is fused to the first video frame, multiple image fusion modes may be determined first based on at least one preset graphic code size, at least one rotation angle, and at least one position, or even at least one graphic code shape. Then, for each image fusion mode, an image area on the first video frame where the graphic code is located is determined first based on the graphic code size, the rotation angle, and the position (even comprising the shape of the graphic code) in this image fusion mode; then, the size and rotation angle of the graphic code are adjusted based on the graphic code size and the rotation angle (even comprising the shape of the graphic code) in this image fusion mode; finally, the adjusted graphic code is added to the above image area of the first video frame, so as to obtain a video frame fused with the graphic code. Finally, for multiple video frames fused with the graphic code and corresponding to the same first video frame, a video frame with the highest similarity to the first video frame is selected as the above third video frame. That is to say, through the above operations, the best fusion mode of the graphic code and the current first video frame may be found by traversing different graphic code sizes, different graphic code rotation angles, and different positions in the video frame. That is to say, the above third video frame obtained by the above method is an image obtained by fusing the graphic code with the current first video frame in the best image fusion mode (the best size, the best selection angle, and the best position).

In addition, considering that the additional information carried by the above graphic code usually needs to be obtained by the user by scanning the graphic code with the camera of the user terminal, the number of first target video frames fused with the graphic code usually needs to reach a certain proportion in order to meet the user's need to scan the graphic code. Based on this, in the embodiments of the present disclosure, a frame selection ratio may be preset, which represents the proportion of the first target video frames in the first video frames, such as 10%, 15%, or 20%, etc. Based on the above preset frame selection ratio and the number of the first video frames, the specific number of the first target video frames to be selected may be determined. In this way, in the above selection process of the first target video frames, the multiple first video frames with the highest matching degree may be selected as the above first target video frames based on the above number.

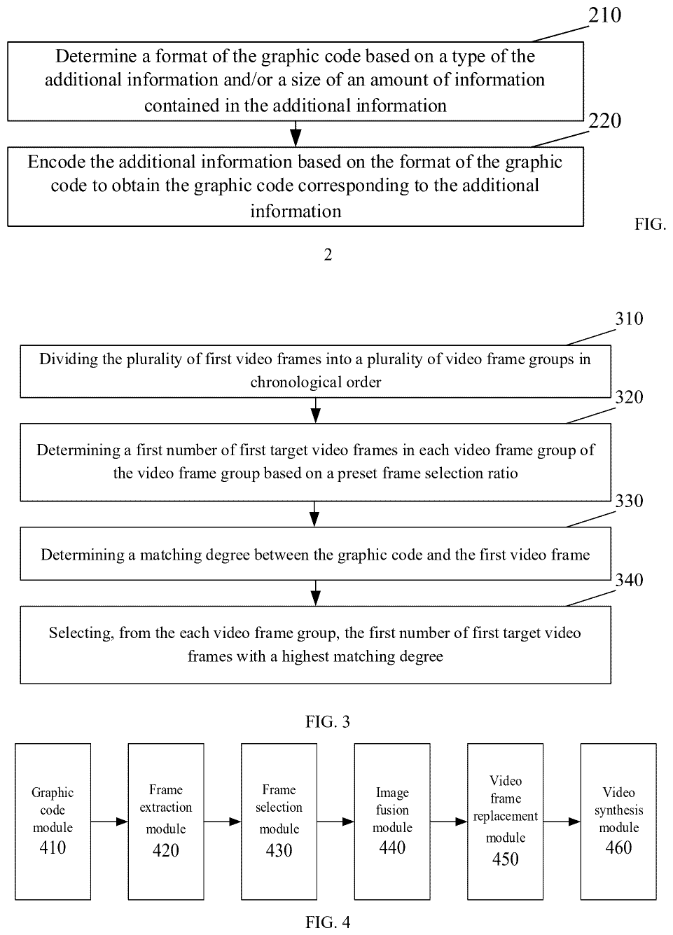

In some other embodiments of the present disclosure, considering that the user can scan the fused graphic code in any time period during the first video playback process, in the above selection process of the first target video frames, it should be ensured as much as possible that the selected first target video frames are evenly distributed in the playing duration of the first video. Based on such consideration, the first target video frame may be selected from the first video frames by a method as shown in FIG. 3. As shown in FIG. 3, the above specific method for selecting the first target video frame from the first video frames may comprise:

In step 310, the plurality of first video frames are divided into a plurality of video frame groups in chronological order.

In the embodiments of the present disclosure, the plurality of first video frames may be evenly divided into a plurality of video frame groups in chronological order, wherein each video frame group contains basically the same number of first video frames. Next, frame selection may be performed in each video frame group according to the above frame selection ratio. Such a frame selection process may ensure that the total number of selected first target video frames meets the requirement of the set frame selection ratio, and may also ensure that the selected first target video frames are basically evenly distributed in the playing duration of the first video. It should be noted that the number of the above video frame groups may be flexibly set according to the number of the first video frames and the frame selection ratio, as long as it is ensured that at least one first target video frame needs to be selected from the each video frame group. The embodiments of the present disclosure do not limit the specific method for grouping the above first video frames.

In step 320, the first number of first target video frames in each video frame group is determined based on the preset frame selection ratio.

As mentioned above, the above frame selection ratio represents the proportion of the first target video frames in the first video frames, such as 10% or 15%, etc. It can be understood that the above frame selection ratio also represents the proportion of the first target video frames in each video frame group in the first video frames in each video frame group. That is, the frame selection ratio of each video frame group is the same as the preset frame selection ratio. In this way, the first number of first target video frames in each video frame group is determined based on the above preset frame selection ratio and the number of the first video frames in each video frame group. It can be understood that if frame selection is performed according to the above first number, the number of the finally selected first target video frames will also meet the set frame selection ratio.

In step 330, the matching degree between the above graphic code and the above first video frame is determined.

For the specific method for determining the matching degree between the above graphic code and the above first video frame in the embodiments of the present disclosure, reference may be made to the method for determining the matching degree between the graphic code and the first video frame in the foregoing embodiment, which will not be repeated here.

In step 340, the first number of first target video frames with the highest matching degree is selected from the each video frame group.

It can be seen that through the above method, the first target video frame most suitable for adding the graphic code (that is, the video frame with the smallest difference before and after the graphic code is fused) may be found from the plurality of first video frames. In addition, by setting a variety of different image fusion modes, the best image fusion mode of the graphic code and the first target video frame may also be determined, comprising: the size (even shape) of the graphic code, the rotation angle of the graphic code, and the position of the graphic code in the first target video frame, etc. Through such selection, the best fusion effect may be obtained after the video frame is fused with the graphic code, thereby minimizing the impact on the user's perception.

For the above step 140, in the embodiments of the present disclosure, the above image generation model may usually be implemented by a Diffusion Model obtained through training.

Specifically, the above diffusion model may comprise: one of a Stable Diffusion Model comprising a control network (ControlNet) plug-in, a diffusion model (DiT, Diffusion Transformer) based on a Transformer architecture, a T2I-Adapter, etc. The above Stable Diffusion Model can generate pictures with different contents and styles based on text descriptions, and can also modify and beautify existing pictures. ControlNet is a plug-in for controlling image generation, allowing users to guide and control image generation more precisely. Through this control, the fusion of the graphic code into the video frame can be realized in the process of generating or modifying the image. In addition, as an alternative, the above DiT and T2I-Adapter have similar functional characteristics to the above Stable Diffusion Model comprising ControlNet, and can also realize the purpose of fusing the graphic code into the video frame in the process of generating or modifying the image.

It should be noted that, in some embodiments of the present disclosure, the above best image fusion mode of the graphic code and the first target video frame obtained in step 130 may also be input into the above image generation model as a control condition, so as to realize more precise guidance and control of the editing of the video frame, thereby achieving a better fusion effect of the video frame and the graphic code.

Next, after obtaining the multiple second target video frames, in step 150 and step 160, the corresponding first target video frame in the above multiple first video frames may be replaced with the above second target video frames to obtain multiple second video frames. That is, the corresponding first target video frame is replaced with the second target video frame, while the first video frames that have not been selected as the first target video frames are retained and still arranged in chronological order to obtain multiple second video frames. Finally, the multiple second video frames are re-synthesized into a second video. It can be understood that, compared with the first video, the above second video has some video frames in which graphic codes for carrying the additional information are fused. In this way, during the playback process of the second video, the user may use the camera of the user terminal to scan the images of the second video, and obtain corresponding additional information, for example, additional text information or other types of additional information, etc., through decoding after the graphic code fused into some video frames is scanned.

It can be seen that some embodiments of the present disclosure provide a solution for fusing additional information into a video image, by which additional information can be fused into multiple video frames of a video in the form of a graphic code. The solution provided by the embodiments of the present disclosure can turn a video into a video that can be scanned while keeping the content of the video image. Further, the solution provided by the embodiments of the present disclosure reduces the sense of incongruity of the graphic code in the video image through a fusion algorithm for image generation and control, so that the graphic code fused into the video frame can be fused with the video image, and thus the overall perception of the user on the video is not affected.

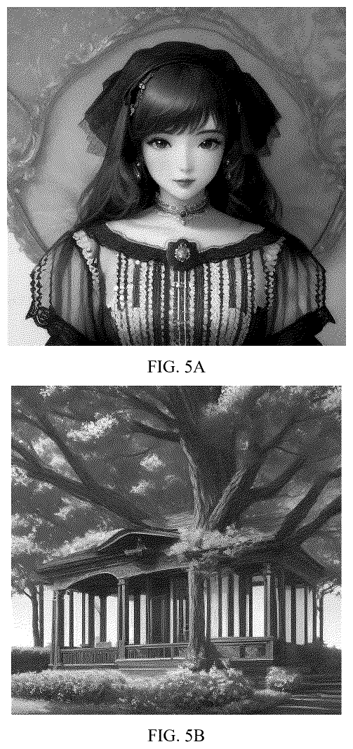

Corresponding to the above video processing method, some embodiments of the present disclosure further disclose a video processing apparatus. FIG. 4 shows an internal structure of a video processing apparatus according to some embodiments of the present disclosure. As shown in FIG. 4, the above video processing apparatus may comprise the following comprises:
a graphic code module 410 configured to generate a graphic code based on additional information to be fused into a first video;
a frame extraction module 420 configured to obtain a plurality of first video frames of the first video;
a frame selection module 430 configured to determine at least one first target video frame from the plurality of first video frames based on the graphic code;
an image fusion module 440 configured to fuse the graphic code with each first target video frame by using the graphic code as a control condition and the first target video frame as an input condition, to obtain a second target video frame corresponding to the first target video frame and fused with the graphic code, for each first target video frame;
a video frame replacement module 450 configured to replace the first target video frame in the plurality of first video frames with a corresponding second target video frame to obtain a plurality of second video frames; and
a video synthesis module 460 configured to generate a second video based on the plurality of second video frames.

For the specific implementation of each of the above modules, reference may be made to the foregoing method and the drawings, and details will not be repeated here. For the convenience of description, the above apparatus is described by dividing it into various modules according to functions. Of course, when implementing the present disclosure, the functions of the modules may be implemented in one or more pieces of software and/or hardware. The apparatus according to the above embodiments is used to implement the corresponding video processing method in any of the foregoing embodiments, and has the beneficial effects of the corresponding method embodiments, which will not be repeated here.

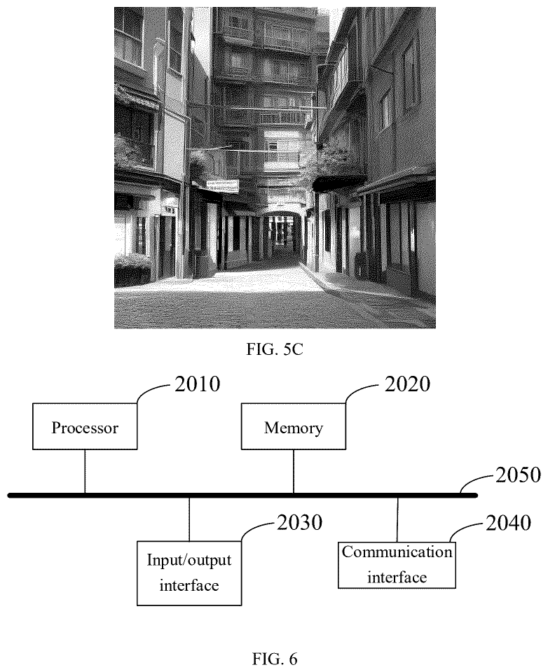

FIG. 5A, FIG. 5B, and FIG. 5C respectively give examples of a first target video frame fused with a graphic code obtained by using the video processing method according to some embodiments of the present disclosure. Graphic codes have been fused into the video frames shown in FIG. 5A to FIG. 5C, and the fused graphic codes may all be recognized by using a camera of a user terminal. Moreover, it can be seen from FIG. 5A to FIG. 5C that, through the method of the embodiments of the present disclosure, a graphic code (such as the clothing pattern of the person in FIG. 5A, the arrangement of the wooden columns of the house in FIG. 5B, and the doors and windows of the store in FIG. 5C) may be fused into each video frame without “traces”, achieving “perfect” fusion with the video frame and completely not affecting the user's perception of the video.

Based on the same inventive concept, corresponding to any of the above method embodiments, the present disclosure further provides an electronic device, comprising: a memory, a processor, and a computer program stored in the memory and executable on the processor, wherein the processor, when executing the program, implements the video processing method according to any of the above embodiments.

FIG. 6 shows a schematic diagram of a more specific hardware structure of an electronic device according to this embodiment. The device may comprise: a processor 2010, a memory 2020, an input/output interface 2030, a communication interface 2040, and a bus 2050. The processor 2010, the memory 2020, the input/output interface 2030, and the communication interface 2040 communicate and are connected to each other inside the device through the bus 2050.

The processor 2010 may be implemented by using a general-purpose central processing unit (CPU), a microprocessor, an application-specific integrated circuit (ASIC), or one or more integrated circuits, and is configured to execute relevant programs to implement the technical solutions provided by some embodiments of the present disclosure.

The memory 2020 may be implemented in a form such as a read-only memory (ROM), a random access memory (RAM), a static storage device, or a dynamic storage device. The memory 2020 may store an operating system and other applications. When the technical solutions provided by some embodiments of the present disclosure are implemented through software or firmware, related program code is stored in the memory 2020 and invoked by the processor 2010 for execution.

The input/output interface 2030 is configured to connect to an input/output device to implement information input and output. The input/output device may be configured as a component in the device, or may be externally connected to the device to provide a corresponding function. The input device may comprise a microphone, various sensors, and the like, and the output device may comprise a display, a speaker, a vibrator, an indicator light, and the like.

The communication interface 2040 is configured to connect to a communication module (not shown in the figure) to implement communication interaction between the device and other devices. The communication module may implement communication in a wired manner (for example, USB, network cable, etc.), or may also implement communication in a wireless manner (for example, mobile network, WIFI, Bluetooth, etc.).

The bus 2050 comprises a path for transmitting information between components of the device (for example, the processor 2010, the memory 2020, the input/output interface 2030, and the communication interface 2040).

It should be noted that although the above device only shows the processor 2010, the memory 2020, the input/output interface 2030, the communication interface 2040, and the bus 2050, during a specific implementation process, the device may also include other components necessary for achieving normal operation. In addition, those skilled in the art can understand that the above device may also only include components necessary for implementing the solutions of the embodiments of the present disclosure, and may not include all components shown in the figure.

The electronic device according to the above embodiments is used to implement the corresponding video processing method in any of the foregoing embodiments, and has the beneficial effects of the corresponding method embodiments, which will not be repeated here.

Based on the same inventive concept, corresponding to any of the above method embodiments, the present disclosure further provides a non-transitory computer-readable storage medium, wherein the non-transitory computer-readable storage medium stores computer instructions, and the computer instructions are used to cause a computer to perform the video processing method according to any of the above embodiments.

The computer-readable medium in some embodiments includes permanent and non-permanent, removable and non-removable media, and information storage may be implemented by any method or technique. Information may be computer-readable instructions, data structures, program modules, or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, compact disc read-only memory (CD-ROM), digital versatile disc (DVD) or other optical storage, magnetic cassette, magnetic tape magnetic disk storage or other magnetic storage devices, or any other non-transmission medium, which may be used to store information accessible by a computing device.

The computer instructions stored in the storage medium of the above embodiments are used to cause the computer to perform the task processing method according to any of the above embodiments, and have the beneficial effects of the corresponding method embodiments, which will not be repeated here.

Those of ordinary skill in the art should understand that the discussion of any of the above embodiments is only exemplary, and is not intended to imply that the scope of the present disclosure (including the claims) is limited to these examples. Under the idea of the present disclosure, the technical features in the above embodiments or different embodiments may also be combined, and steps may be implemented in any order, and there are many other variations in different aspects of the embodiments of the present disclosure as described above, which are not provided in detail for the sake of brevity.

In addition, in order to simplify the description and discussion, and without making the embodiments of the present disclosure difficult to understand, well-known power/ground connections to integrated circuit (IC) chips and other components may or may not be shown in the provided drawings. Furthermore, the apparatus may be shown in the form of a block diagram, so as to avoid making the embodiments of the present disclosure difficult to understand, and this also takes into account the fact that the details of the implementations of these block diagram apparatus are highly dependent on the platform on which the embodiments of the present disclosure are to be implemented (that is, these details should be completely within the understanding of those of ordinary skill in the art). In the case where specific details (for example, circuits) are set forth to describe exemplary embodiments of the present disclosure, it is obvious to those of ordinary skill in the art that the embodiments of the present disclosure may be implemented without these specific details or with variations of these specific details. Therefore, these descriptions should be considered as illustrative rather than restrictive.

Although the present disclosure has been described in combination with specific embodiments of the present disclosure, many alternatives, modifications, and variations of these embodiments will be apparent to those of ordinary skill in the art from the foregoing description. For example, other memory architectures (for example, dynamic RAM (DRAM)) may use the discussed embodiments.

The embodiments of the present disclosure are intended to cover all such alternatives, modifications, and variations that fall within the broad scope of the appended claims. Therefore, any omission, modification, equivalent substitution, improvement, etc. made within the spirit and principles of the embodiments of the present disclosure should be included in the protection scope of the present disclosure.

What is claimed is:

1. A video processing method, comprising:
generating a graphic code based on additional information to be fused into a first video;
obtaining a plurality of first video frames of the first video;
determining at least one first target video frame from the plurality of first video frames based on the graphic code;
for each first target video frame of the first target video frames, fusing the graphic code with the first target video frame by using the graphic code as a control condition and the first target video frame as an input condition, to obtain a second target video frame corresponding to the first target video frame and fused with the graphic code;
replacing the first target video frame in the plurality of first video frames with a corresponding second target video frame to obtain a plurality of second video frames; and
generating a second video based on the plurality of second video frames.

2. The method according to claim 1, wherein the generating a graphic code based on additional information to be fused into a first video comprises:
determining a format of the graphic code based on a type of the additional information and/or a size of an amount of information contained in the additional information, wherein the format of the graphic code comprises a bar code and a two-dimensional code; and
encoding the additional information based on the format of the graphic code to obtain the graphic code.

3. The method according to claim 1, wherein the obtaining the plurality of first video frames of the first video comprises:
performing frame extraction processing on the first video to obtain the plurality of first video frames.

4. The method according to claim 1, wherein the determining at least one first target video frame from the plurality of first video frames based on the graphic code comprises:
determining a matching degree between each first video frame of the first video frames and the graphic code; and
selecting the at least one first target video frame from the plurality of first video frames based on a preset frame selection ratio and the matching degree between the first video frame and the graphic code.

5. The method according to claim 1, wherein the determining at least one first target video frame from the plurality of first video frames based on the graphic code comprises:
determining a matching degree between each first video frame of the first video frames and the graphic code;
dividing the plurality of first video frames into a plurality of video frame groups in chronological order;
determining a first number of first target video frames in each video frame group of the video frame groups based on a preset frame selection ratio; and
selecting, from the each video frame group, the first number of the first video frames with a highest matching degree as the first target video frames.

6. The method according to claim 4, wherein the determining a matching degree between the first video frame and the graphic code comprises:
for the first video frame, fusing the graphic code into the first video frame to obtain a third video frame; and
determining a similarity between the third video frame and a corresponding first video frame of the third video frame, and using the similarity as the matching degree between the first video frame and the graphic code.

7. The method according to claim 6, wherein fusing the graphic code into the first video frame comprises:
determining at least one image fusion mode, based on at least one of a preset graphic code size, at least one rotation angle, and at least one position;
for each image fusion mode, determining an image area on the first video frame where the graphic code is located based on the graphic code size, the rotation angle, and the position in the image fusion mode, adjusting a size and a rotation angle of the graphic code based on the graphic code size and the rotation angle in the image fusion mode, and adding adjusted graphic code to the image area of the first video frame to obtain a video frame fused with the graphic code; and
selecting, from a plurality of video frames fused with the graphic code and corresponding to a same first video frame, a video frame with a highest similarity to the first video frame as the third video frame.

8. The method according to claim 1, wherein the image generation model is implemented by a diffusion model obtained through training.

9. The method according to claim 8, wherein the diffusion model comprises one of a stable diffusion model comprising a control network plug-in, a diffusion model based on a transformer architecture, or a T2I adapter.

10. An electronic device, comprising: a memory, a processor, and a computer program stored in the memory and executable on the processor, wherein the processor, when executing the program, implements a video processing method, comprising:
generating a graphic code based on additional information to be fused into a first video;
obtaining a plurality of first video frames of the first video;
determining at least one first target video frame from the plurality of first video frames based on the graphic code;
for each first target video frame of the first target video frames, fusing the graphic code with the first target video frame by using the graphic code as a control condition and the first target video frame as an input condition, to obtain a second target video frame corresponding to the first target video frame and fused with the graphic code;
replacing the first target video frame in the plurality of first video frames with a corresponding second target video frame to obtain a plurality of second video frames; and
generating a second video based on the plurality of second video frames.

11. The electronic device according to claim 10, wherein the generating a graphic code based on additional information to be fused into a first video comprises:
determining a format of the graphic code based on a type of the additional information and/or a size of an amount of information contained in the additional information, wherein the format of the graphic code comprises a bar code and a two-dimensional code; and
encoding the additional information based on the format of the graphic code to obtain the graphic code.

12. The electronic device according to claim 10, wherein the obtaining the plurality of first video frames of the first video comprises:
performing frame extraction processing on the first video to obtain the plurality of first video frames.

13. The electronic device according to claim 10, wherein the determining at least one first target video frame from the plurality of first video frames based on the graphic code comprises:
determining a matching degree between each first video frame of the first video frames and the graphic code; and
selecting the at least one first target video frame from the plurality of first video frames based on a preset frame selection ratio and the matching degree between the first video frame and the graphic code.

14. The electronic device according to claim 10, wherein the determining at least one first target video frame from the plurality of first video frames based on the graphic code comprises:
determining a matching degree between each first video frame of the first video frames and the graphic code;
dividing the plurality of first video frames into a plurality of video frame groups in chronological order;
determining a first number of first target video frames in each video frame group of the video frame groups based on a preset frame selection ratio; and
selecting, from the each video frame group, the first number of the first video frames with a highest matching degree as the first target video frames.

15. A non-transitory computer-readable storage medium storing computer instructions, wherein the computer instructions are used to cause a computer to perform a video processing method, comprising:
generating a graphic code based on additional information to be fused into a first video;
obtaining a plurality of first video frames of the first video;
determining at least one first target video frame from the plurality of first video frames based on the graphic code;
for each first target video frame of the first target video frames, fusing the graphic code with the first target video frame by using the graphic code as a control condition and the first target video frame as an input condition, to obtain a second target video frame corresponding to the first target video frame and fused with the graphic code;
replacing the first target video frame in the plurality of first video frames with a corresponding second target video frame to obtain a plurality of second video frames; and
generating a second video based on the plurality of second video frames.

16. The non-transitory computer-readable storage medium according to claim 15 wherein the generating a graphic code based on additional information to be fused into a first video comprises:
determining a format of the graphic code based on a type of the additional information and/or a size of an amount of information contained in the additional information, wherein the format of the graphic code comprises a bar code and a two-dimensional code; and
encoding the additional information based on the format of the graphic code to obtain the graphic code.

17. The non-transitory computer-readable storage medium according to claim 15, wherein the obtaining the plurality of first video frames of the first video comprises:
performing frame extraction processing on the first video to obtain the plurality of first video frames.

18. The non-transitory computer-readable storage medium according to claim 15, wherein the determining at least one first target video frame from the plurality of first video frames based on the graphic code comprises:
determining a matching degree between each first video frame of the first video frames and the graphic code; and
selecting the at least one first target video frame from the plurality of first video frames based on a preset frame selection ratio and the matching degree between the first video frame and the graphic code.

19. The non-transitory computer-readable storage medium according to claim 15, wherein the determining at least one first target video frame from the plurality of first video frames based on the graphic code comprises:
determining a matching degree between each first video frame of the first video frames and the graphic code;
dividing the plurality of first video frames into a plurality of video frame groups in chronological order;
determining a first number of first target video frames in each video frame group of the video frame groups based on a preset frame selection ratio; and
selecting, from the each video frame group, the first number of the first video frames with a highest matching degree as the first target video frames.

20. The non-transitory computer-readable storage medium according to claim 18, wherein the determining a matching degree between the first video frame and the graphic code comprises:
for the first video frame, fusing the graphic code into the first video frame to obtain a third video frame; and
determining a similarity between the third video frame and a corresponding first video frame of the third video frame, and using the similarity as the matching degree between the first video frame and the graphic code.
